(19) United States
(12) Patent Application Publication
(10) Pub. No.: US 2019/0061130 A1
(43) Pub. Date: Feb. 28, 2019

(54) CLAW HAMMER

(71) Applicant: Yung-Shou Chen, Taichung City (TW)

(72) Inventor: Yung-Shou Chen, Taichung City (TW)

(21) Appl. No.: 15/687,216

(22) Filed: Aug. 25, 2017

(51) Int. Cl. B25D 1/04

(52) U.S. Cl. CPC B25D 1/04

(57) ABSTRACT

A claw hammer includes a circular or oval recessed hole located on one lateral wall of a hammerhead thereof, a circular through hole located in a bottom wall of the recessed hole and cut through the other lateral wall of the hammerhead, a V-shaped opening extended from the border of the through hole and defining two abutment edges. When extracting a nail laterally, move the hammerhead horizontally to receive the head of the nail in the through hole and to abut the two abutment edges of the V-shaped opening against the shank of the nail, and then bias the handle of the claw hammer to extract the nail. Thus, the claw hammer provides an added lateral nail extracting function.

### BACKGROUND OF THE INVENTION

### (a) Field of the Invention

The present invention relates to nail pulling tools, and more particularly to a claw hammer that is equipped with a lateral nail extractor for hammering and extracting nails.

### (b) Description of the Prior Art

A main tool for the work of craftsmen today is the hammer, which is used to hammer nails into a wood piece. The nails must be pulled out in a reverse direction if they are distorted or nailed in incorrect positions. In order to avoid replacing the tool when pulling the nail, hammers with a claw at the back of the hammer head were created. When pulling the nail with the claw, attach the V-shaped groove of the claw onto the shank of the nail, and then bias the hammer to pull the nail out of the wood piece.

However, craftsmen may encounter different situations in their work, such as the limitations of the nail workspace, different nailing depth, nail bending, or different application requirements of the claw of the hammerhead. If the claw at the back side of the hammerhead of the hammer in use cannot meet the application requirements, the craftsman must change the tool and select a special nail puller or pliers. This will cause inconveniences to the work.

Therefore, a hammer with a variety of nail pullers (nail extractors pull) would give craftsmen more choices to meet their needs in response to different nail-pulling needs.

U.S. Pat. No. 4,561,635 discloses a nail removing hammer which has at least one nail removing means in addition to a conventional rearwardly extending claw. U.S. Pat. No. 1,660,237 and U.S. application Ser. No. 994,775 provide a nail pulling attachment at the top wall of the hammerhead. U.S. Pat. No. 8,113,488 and U.S. Pat. No. 7,090,197 disclose a hammer with a front extractor at the hammerhead. Thus, different designs of nail extractors can be provided at the hammerhead for different applications so that craftsmen can selectively use different designs of nail extractors according to different application requirements, to conveniently perform their work. There are some hammer designs with a nail extractor at one lateral wall of the hammerhead, however, these designs commonly protrude over the lateral wall of the hammerhead. When using the hammer to hammer a nail, the protruding part of the nail extractor can hit other surrounding objects.

### SUMMARY OF THE INVENTION

The present invention has been accomplished under the circumstances in view. It is therefore the main object of the present invention to provide a claw hammer which comprises a circular or oval recessed hole located on one lateral wall of a block body of a hammerhead thereof, a circular through hole located in a bottom wall of the recessed hole and cut through the other lateral wall of the block body of the hammerhead, a V-shaped opening extended from the border of the through hole and defining two abutment edges. When extracting a nail laterally, move the hammerhead horizontally to receive the head of the nail in the through hole and to abut the two abutment edges of the opening against the shank of the nail, and then bias the handle of the claw hammer to extract the nail.

Preferably, the through hole is a circular through hole for the passing of the head of a nail, and the opening has a V-shaped cross section for enabling the two abutment edges to abut against the shank of any of a variety of nails of different diameters.

Further, the recessed hole can be configured to have a circular or oval cross section so that it can easily and rapidly be processed by a milling cutting tool.

Further, the two opposing lateral walls of the block body are respectively and smoothly terminating in a distal end edge of the claw without protrusions so that the claw hammer is practical for working in a narrow space.

### BRIEF DESCRIPTION OF THE DRAWINGS

FIG. 1 is an oblique top elevational view of a claw hammer in accordance with the present invention.

FIG. 2 is an oblique top elevational view of the hammerhead of the claw hammer, illustrating the structure of a lateral wall of the block body of the hammerhead.

FIG. 3 is a schematic elevational view of a part of the present invention, illustrating the structure of the lateral nail extractor.

FIG. 4 is a schematic front side view of the lateral nail extractor of the claw hammer in accordance with the present invention.

FIG. 5 is a schematic rear side view of the lateral nail extractor of the claw hammer in accordance with the present invention.

FIG. 6 is a schematic left side view of the lateral nail extractor of the claw hammer in accordance with the present invention.

FIG. 7 is a schematic right side view of the lateral nail extractor of the claw hammer in accordance with the present invention.

FIG. 8 is a schematic top view of the lateral nail extractor of the claw hammer in accordance with the present invention.

FIG. 9 is a schematic bottom view of the lateral nail extractor of the claw hammer in accordance with the present invention.

FIG. 10 is a schematic applied view of the claw hammer of the present invention, illustrating the nail head inserted into the through hole.

FIG. 11 is a schematic applied view of the claw hammer of the present invention, illustrating the two abutment edges of the opening abutted against the shank of the nail.

FIG. 12 is a schematic applied view of the claim hammer of the present invention, illustrating the claw hammer being biased to extract the nail.

### DETAILED DESCRIPTION OF THE PREFERRED EMBODIMENTS

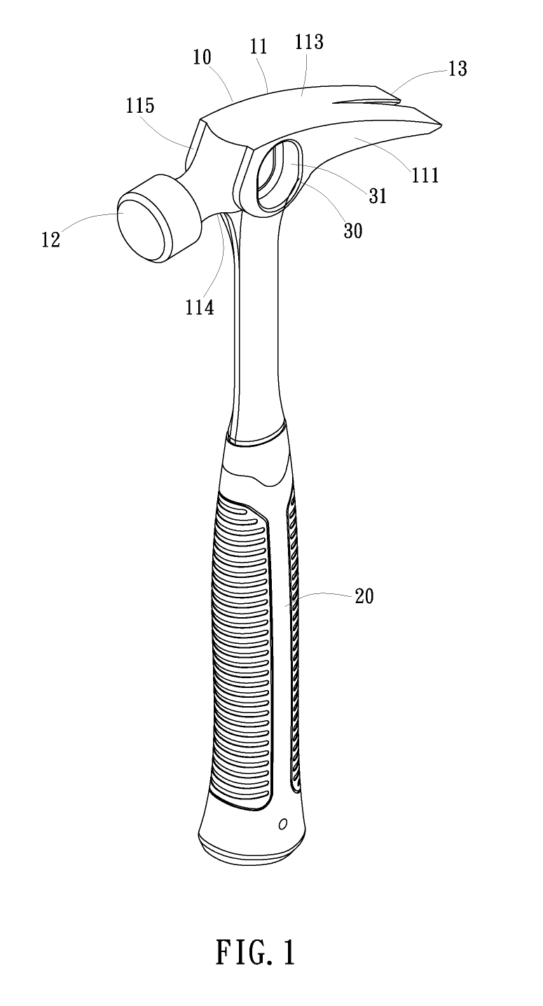

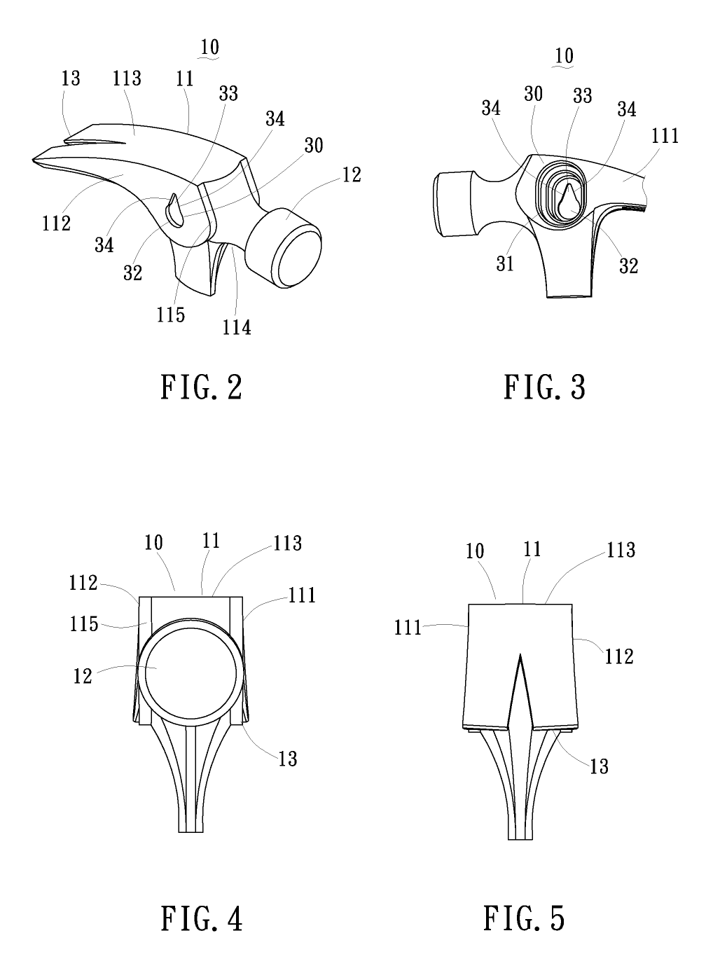

Referring to FIGS. 1-3, a claw hammer in accordance with the present invention is shown. The claw hammer comprises a claw hammerhead 10 and a handle 20 connected with the hammerhead 10.

The hammerhead 10 is made of metal such as carbon steel or alloy steel, comprising a block body 11, a bell 12 formed integral with a front end of the block body 11, a claw 13 formed integral with an opposing rear end of the block body 11, and a lateral nail extractor 30 formed in one lateral side of the block body 11. The lateral nail extractor 30 comprises a recessed hole 31 located on one lateral wall 111 of the block body 11, a through hole 32 located in a bottom wall of the recessed hole 31 and cut through an opposite lateral wall 112 of the block body 11, and an opening 33 extended from the through hole 32 in direction toward a top wall 113 (or bottom wall 114) of the block body 11 for attaching onto the shank of a nail (not shown) and defining two abutment edges 34 at two opposite lateral sides thereof for abutment against two opposite sides of the shank of the nail. Thus, by means of the lateral nail extractor 30, the claw hammer of the present invention is practical for extracting a nail laterally.

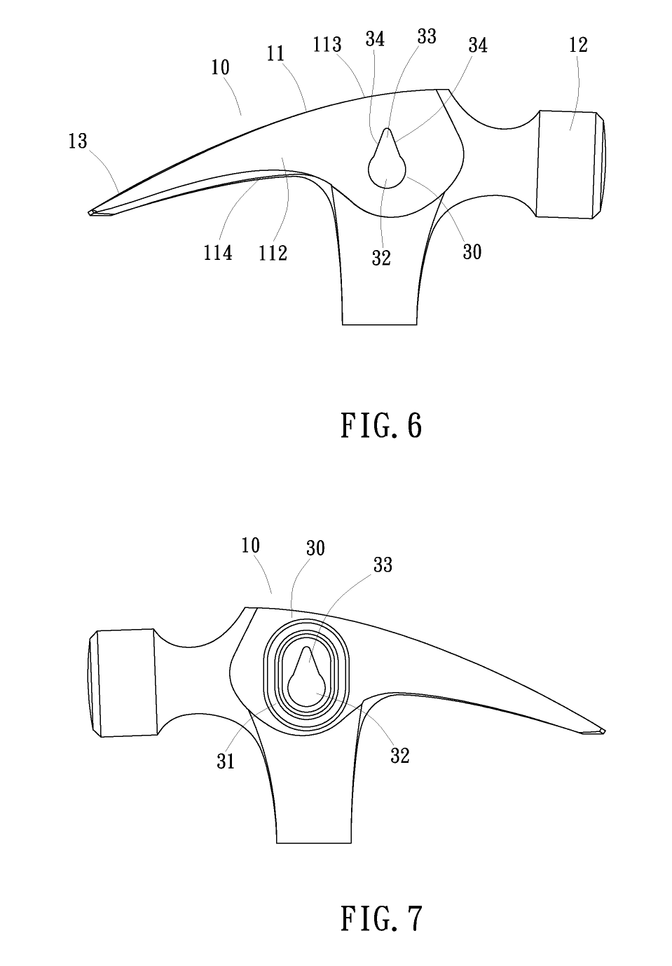

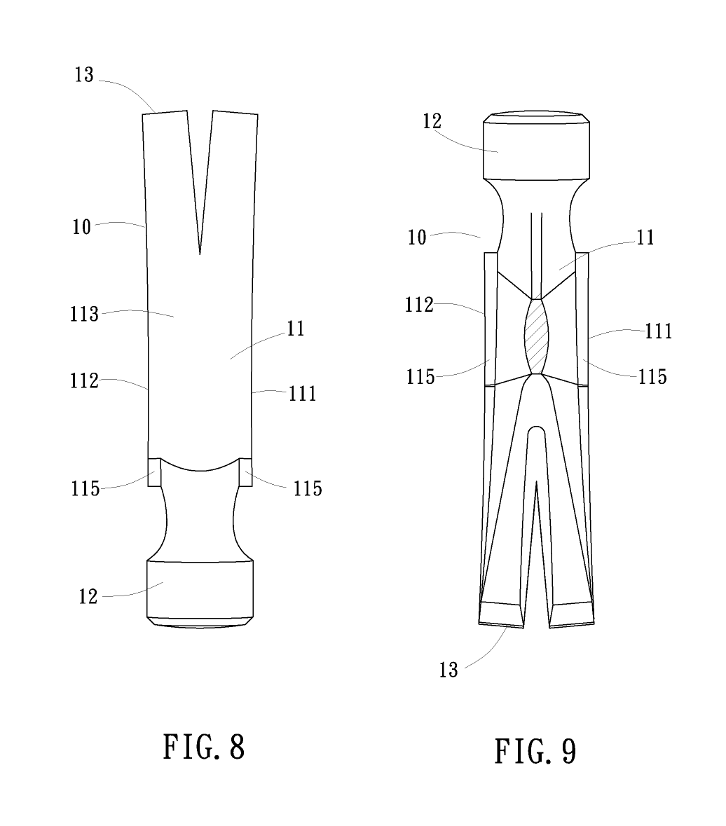

Referring to the six views shown in FIGS. 4-9, the two opposite lateral walls 111,112 of the block body 11 are respectively terminating in a distal end edge of the claw 13 so that the two opposite lateral walls 111,112 are maintained smooth without any protrusion to interfere with the operation of the claw hammer in a narrow space (such as hammering a nail). Alternatively, the block body 11 of the hammerhead 10 can be configured to provide two protruding blocks 115 that are respectively disposed at two opposite lateral sides and respectively terminating in the claw 13. The two opposite lateral walls 111,112 are respectively formed on the protruding blocks 115. The through hole 32 and the opening 33 cut through protruding blocks 115 and the lateral walls 111,112. The through hole 32 is preferably a circular through hole for the passing of the head of a nail. The opening 33 is preferably an opening with a V-shaped cross section so that the two abutment edges 34 can be tightly abutted against the shank of a nail of any size, enabling the nail extractor 30 to extract nails of different sizes. Further, the recessed hole 31 is preferably a stepped recessed hole, having a circular or oval cross section for easy formation by a milling cutting tool.

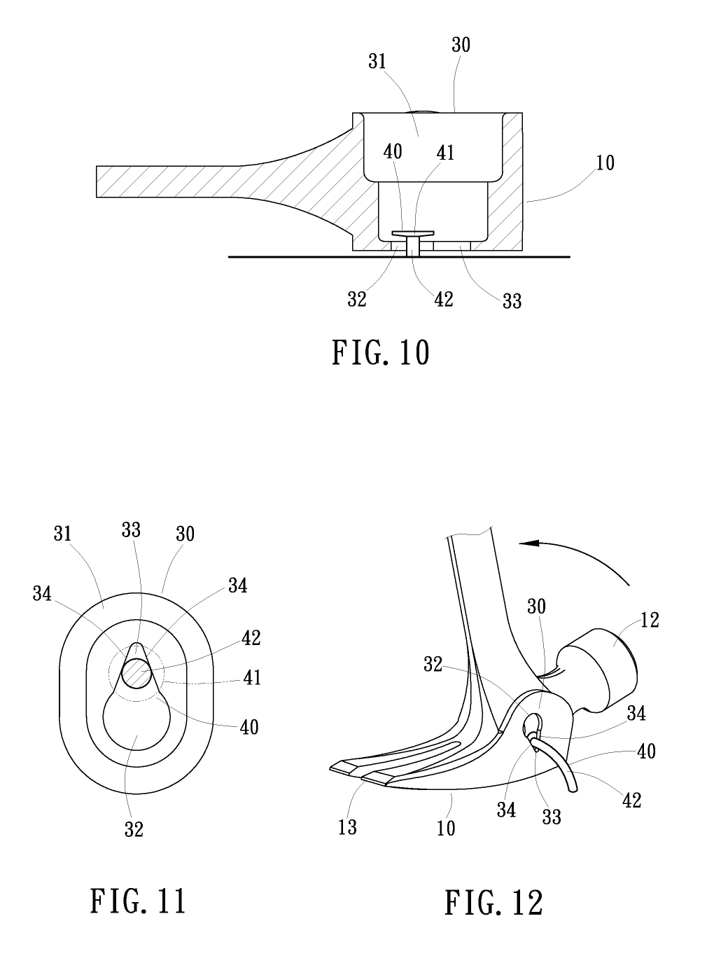

When using the nail extractor 30 of the claw hammer of the present invention to extract a nail, as illustrated in FIG. 10, hold the claw hammer to move the hammerhead 10 horizontally toward the nail 40 to be extracted so that the head 41 of the nail 40 is inserted into the through hole 32, and then continuously move the hammerhead 10 horizontally to abut the two abutment edges 34 of the opening 33 against the shank 42 below the nail head 41 of the nail 40 (see FIG. 11). At this time, as illustrated in FIG. 12, the user can bias the handle 20 to extract the nail 40. In addition to the known structure of the claw 13 at the rear end of the hammerhead 10, the claw hammer of the present invention provides a lateral nail extractor 30, which allows the user to have more choices of use, in response to the needs of various nail extracting applications.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A claw hammer, comprising a hammerhead and a handle connected with said hammerhead, wherein said hammerhead comprises a block body, a bell formed integral with a front end of said block body, a claw formed integral with an opposing rear end of said block body and a lateral nail extractor formed in one of two opposite lateral sides of said block body, said lateral nail extractor comprising a recessed hole located on one said lateral wall of said block body, a through hole located in a bottom wall of said recessed hole and cut through the opposite said lateral wall of said block body and an opening extended from said through hole in direction toward one of opposing top wall and bottom wall of said block body for attaching onto the shank of a nail and defining two abutment edges at two opposite lateral sides thereof for abutment against two opposite sides of the shank of the said nail.

2. The claw hammer block body as claimed in claim 1, wherein said two opposing lateral walls of said block body are respectively terminating in a distal end edge of said claw.

3. The claw hammer block body as claimed in claim 2, wherein said through hole is a circular through hole.

4. The claw hammer block body as claimed in claim 3, wherein said opening has a V-shaped cross section.

5. The claw hammer block body as claimed in claim 1, wherein said recessed hole is a stepped recessed hole.

6. The claw hammer block body as claimed in claim 5, wherein said recessed hole is configured to have a circular or oval cross section.

7. The claw hammer block body as claimed in claim 1, wherein said block body comprises two protruding blocks respectively located on two opposite sides thereof and are respectively terminating in said claw; said two opposing lateral walls of said block body are respectively formed in said two protruding blocks.
